(19) United States
(12) Patent Application Publication
(10) Pub. No.: US 2013/0193692 A1
(43) Pub. Date: Aug. 1, 2013

(54) Electric Power Generating Speed Bump

(71) Applicant: Victor Dmitriev, Moscow (RU)

(72) Inventor: Victor Dmitriev, Moscow (RU)

(21) Appl. No.: 13/363,395

(22) Filed: Feb. 1, 2012

(51) Int. Cl. F03G 7/08

(52) U.S. Cl. 290/1 R

(57) ABSTRACT

An electric generating speed bump is described, which combines two applications: Firstly—it works as a usual commonly and widely used speed bump (a humplike bar which fixed to the surface across the road to slow down passing vehicles); Secondly—it converts the kinetic energy and weight force of the vehicle which passes the speed bump to electric energy. The electric energy is generated by linear electric generator (which is installed inside the speed bump) when the wheels of a vehicle roll over the speed bump.

The electric generating speed bump generates clean ecologically friendly renewable energy, reduces consumption of fossil fuels in national economy.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention pertains to new renewable energy generation technologies. The implementation of the proposed invention will contribute to development of lower carbon emission economy, reduction usage of fossil fuels. The inventor does not know any related documents or references to specific documents, which are related to the invention.

### BRIEF SUMMARY OF THE INVENTION

The invention is a specially designed road speed bump (here and after referred to as the “Device”) used as typical vehicle speed limiting facility which at the same time generates renewable electric energy. The electric power generated by the Device can be used as additional source of electric power for nearby consumers—households, schools, office buildings, shopping malls, etc. or by electric utilities.

### BRIEF DESCRIPTION OF THE SEVERAL VIEWS OF THE DRAWING

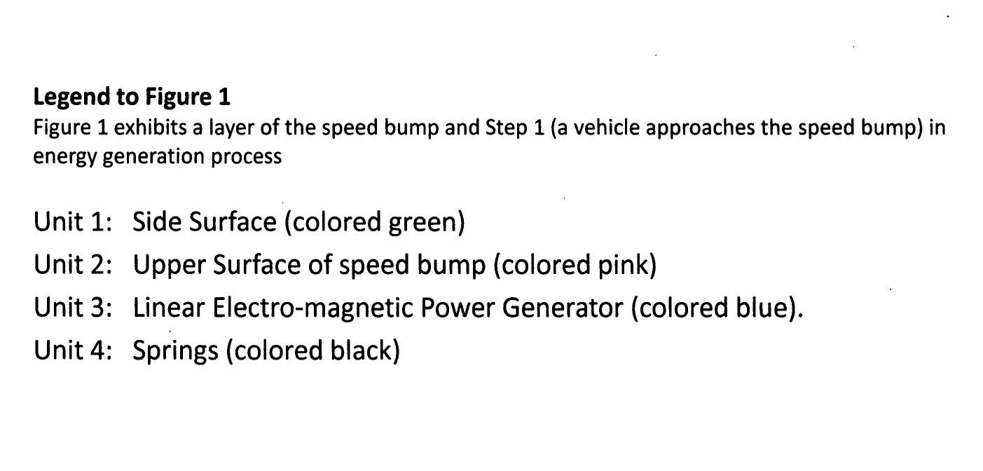

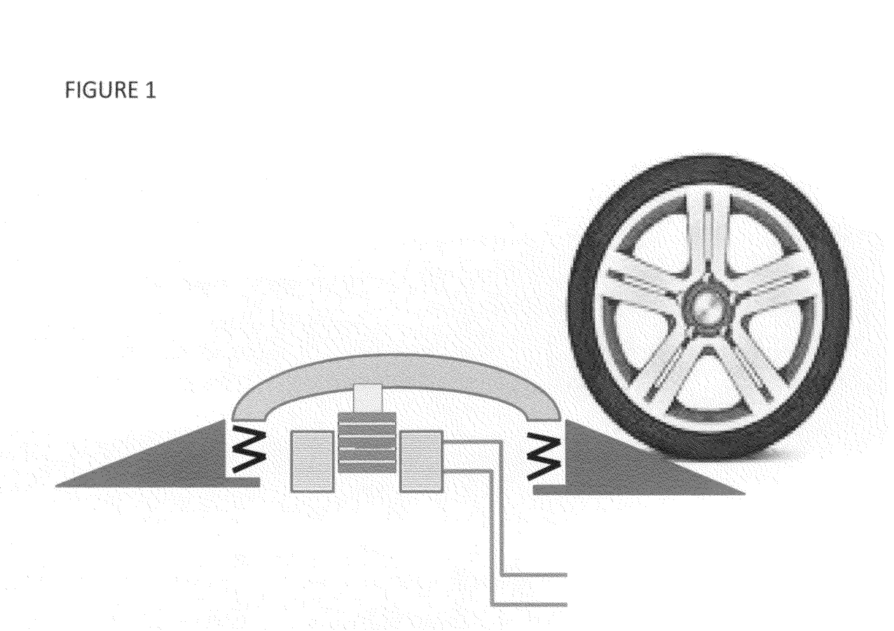

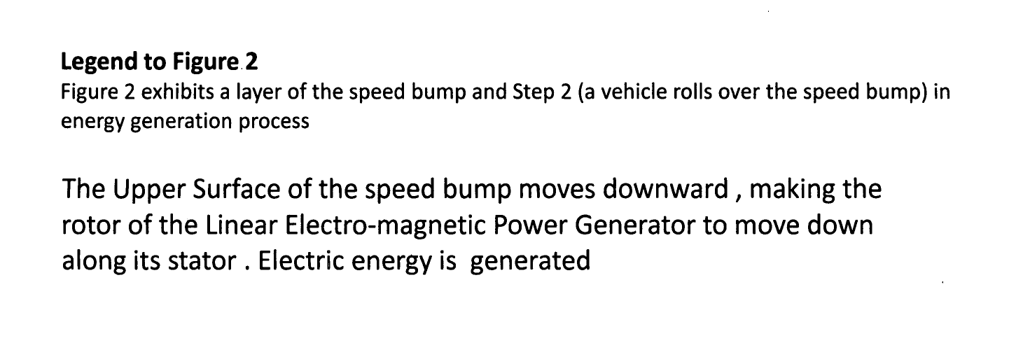

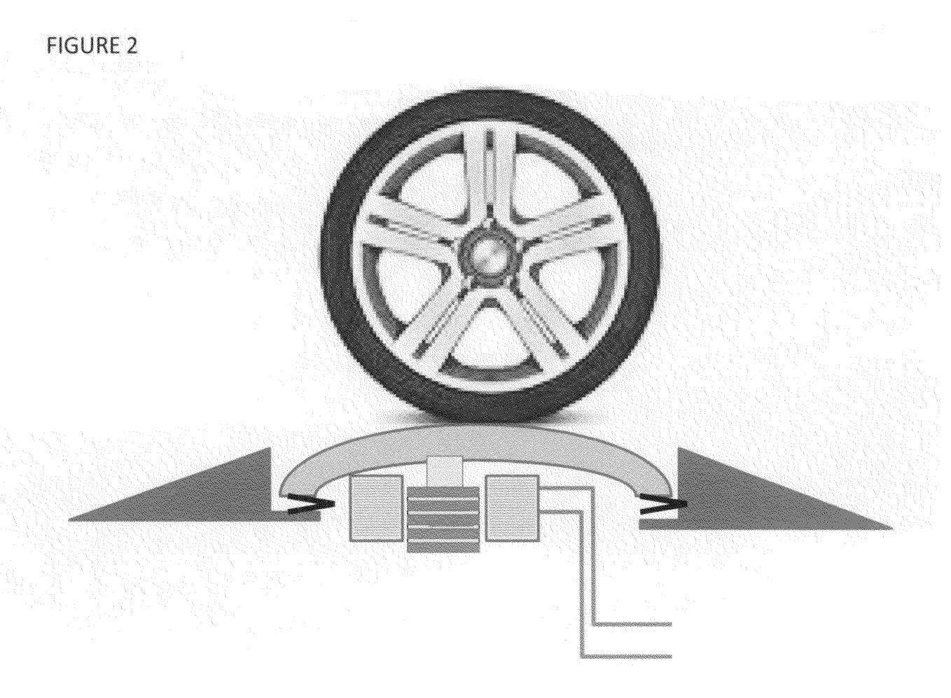

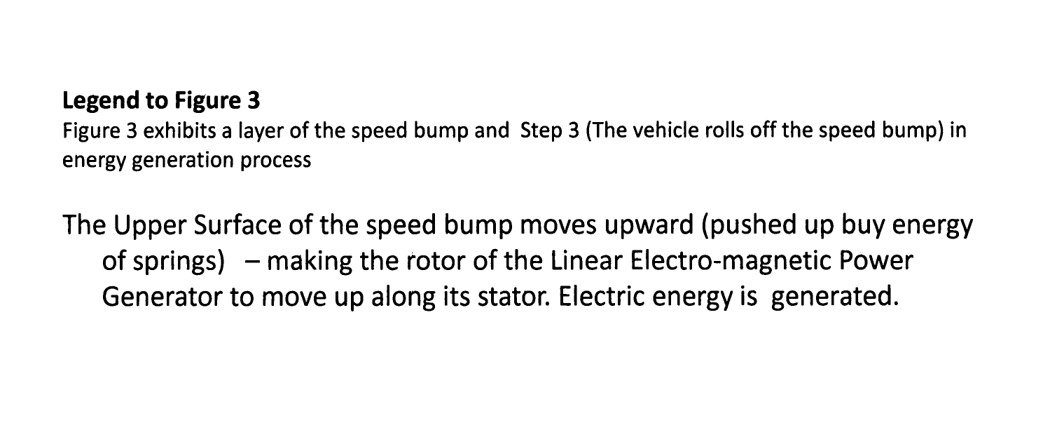

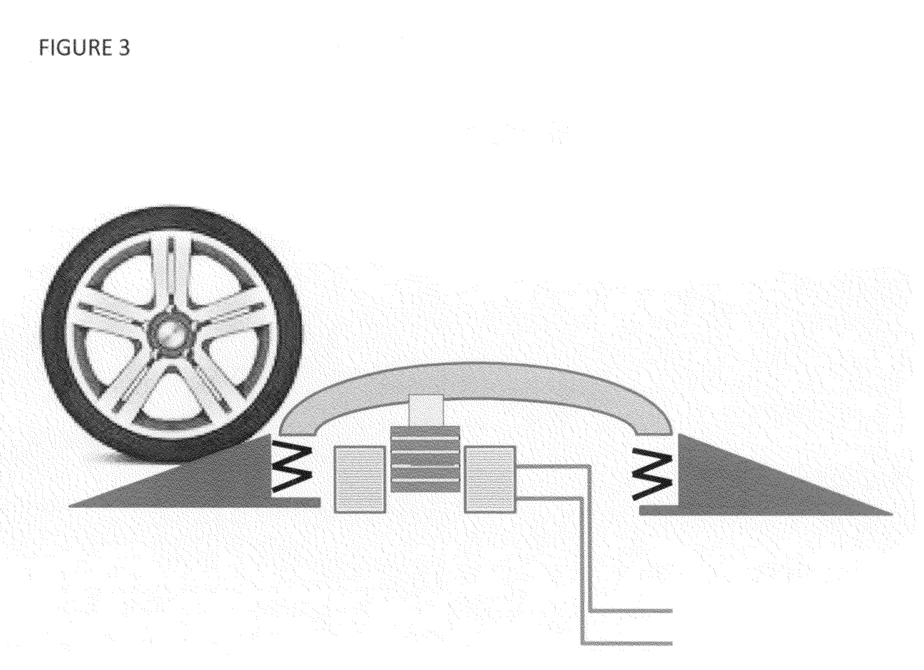

The Drawing section of the Specification consists of FIG. 1, FIG. 2, FIG. 3. It shows the main units of the Device and explains the cycle of generation of renewable electric power in three corresponding Steps.

### DETAILED DESCRIPTION OF THE INVENTION

The Device consists of four units:
1. A Side Surface of the Device. It firmly attached to the pavement of the road to slow down the fast moving car (as it does in usual speed bumps).
2. The Upper Surface of the speed bump. It receives kinetic energy and weight force of the vehicle when the car rolls over and has and ability to slightly move downward and upward.
3. A Linear Electro-magnetic Power Generator, rotor (or stator) of which is firmly attached to the upper surface of the Device. It converts the kinetic energy and weight force of a car to electric power. A number of foregoing generators attached to the Upper Surface can vary depending on particular engineering solution.
4. Springs that push the upper surface of the speed bump upwards when the vehicle has passed speed bump and rolled off the Device.

The process of generation of renewable energy by the Device is set forth below:

When wheels of any passing car roll over the speed bump, the weight and motion energy of the vehicle make the upper surface of the speed bump move downwards. The energy of the downward movement of the surface makes a linear electro-magnetic generator to generate electric energy.

When the wheels of the car roll off the speed bump the Surface (Unit 1) is moved back (upward) to initial position by springs installed inside the Device. The upward movement of the surface can also be converted into electric energy the same way the downward movement is being converted. The downward and upward movements of Unit 1 form a cycle of constant generation of renewable electric power.

### DRAWINGS

The renewable energy generation cycle is shown below in three steps with corresponding three figures.

1. An electric power generating speed bump comprising: Side Surface (Unit1), Upper Surface of speed bump (Unit2), single Linear Electro-magnetic Power Generator (Unit3), Springs (Unit 4)

2. An electric power generating speed bump comprising: Side Surface (Unit1), Upper Surface of speed bump (Unit2), a number of Linear Electro-magnetic Power Generators (Unit3), Springs (Unit 4)
